(19) United States
(12) Patent Application Publication
(10) Pub. No.: US 2008/0052127 A1
(43) Pub. Date: Feb. 28, 2008

(54) System and method for providing electronic medical records

(76) Inventors: Eric Rosenfeld, Randolph, NJ (US); Milton Hauser, Cedar Knolls, NJ (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/895,596

(22) Filed: Aug. 24, 2007

Related U.S. Application Data
(60) Provisional application No. 60/840,652, filed on Aug. 28, 2006.

(51) Int. Cl. G06Q 50/00; G06F 17/30; G06F 17/40

(52) U.S. Cl. 705/3

(57) ABSTRACT

A system and method for collecting, aggregating and providing electronic medical records is presented. A patient enters information regarding medical services providers to a medical records service as part of a digital medical profile. The patient further submits a records authorization authorizing the release of the patient's medical records to the medical records service. Health care records are requested from each of the patient's medical services providers, and upon receipt, entered into a database. An interactive healthcare calendar permits a patient to enter medical appointments. Updates to the medical records are requested from relevant medical services providers at regular intervals, or after an appointment in the interactive healthcare calendar. The stored medical records are transferred to a portable records storage device such as a USB key, which may be carried by the patient for use by medical services providers, or in case emergency medical treatment is needed.

### CROSS REFERENCE TO RELATED APPLICATIONS

This application claims the benefit of the Provisional Patent Application, Ser. No. 60/840,652, filed on Aug. 28, 2006.

### BACKGROUND

1. Technical Field

The present principles relate to a system and method for acquiring, compiling and providing electronic medical records.

2. Description of the Related Art

In recent years, the medical field has struggled to keep pace with the volume of patient records. As the amount of documentation required for medical procedures has flourished, the ability of patients and medical services providers to track and manage medical records has faltered. Electronic record keeping provides a method for compiling and aggregating the voluminous medical records that patients may accrue during their lifetime.

Experts within the industry, and within government, have called for a move from physical paper records to electronic medical records. The use of electronic medical records provides for greater record portability, lower risk of medical error, and increased treatment accuracy.

However, the use of a global medical data base, where practitioners all have unfettered access to patient medical records gives rise to serious patient privacy concerns. Such a medical records database and permitting multiple users to view a particular patient's information cold possibly create security problems, or allow non-medical personnel to access vital patient medical data.

### SUMMARY

Presented herein are a system and method for acquiring, compiling, and providing electronic medical records.

In one useful embodiment, a method for providing a medical records service for gathering and storing medical records of a patient may include the steps of enrolling a patient, including gathering information for a patient's medical service providers and receiving the patient's authorization to request medical records. The method may also include requesting medical records from each of the patient's medical services providers, receiving and entering the requested medical records into a database, and copying and updating the medical records onto a portable records storage device. The method may optionally include requesting updated medical records from at least one of the medical service providers. The medical records and records updates may be requested automatically, at predetermined intervals, or in response to an event entered into an interactive healthcare calendar. Any costs associated with the duplication of the medical records by the medical services providers may be automatically billed to a patient.

A system for providing a medical records service may include a database for storing of a patient's medical records and account information, a records entry module configured to collect and receive medical records, a records storage module configured to store received medical records in the database, and a records retrieval module for retrieving records from the database. The system may further include an interface layer having a billing and payment module for collecting patient account billing and payment information to be stored in the database, and a digital medical profile module for collecting and storing a patient's digital medical profile the digital medical profile comprising the medical service provider information of the patient. A portable record storage device data interface may also be included to retrieve medical records through the records retrieval module and copy the medical records onto a portable records storage device.

### BRIEF DESCRIPTION OF DRAWINGS

The disclosure will provide details in the following description of preferred embodiments with reference to the following figures wherein:

FIG. 1 is a diagram showing a network for communication between a client computer and a medical records service according to the present principles;

FIG. 2 is a block/flow diagram depicting a method for acquiring, compiling, updating and providing electronic medical records according to the present principles; and

FIG. 3 is a block diagram showing a system for acquiring, compiling, and providing electronic medical records, according to the present principles.

### DETAILED DESCRIPTION

An improved system and method is presented for acquiring, compiling, and providing electronic medical records. In accordance with one useful embodiment of the present invention, medical records may be gathered by a medical records service from a patient's various medical services providers, and aggregated and stored for the patient. The patient may then download and store his or her own medical records on a Portable Record Storage (PRS) Device. The PRS device may be carried with the patient, permitting medical services providers or emergency medical personnel to access the patient's medical records quickly and accurately.

Here, the term “medical records” may be used to denote records of treatment, diagnosis, immunization, prescriptions, or any other record generated in connection with, or for the purpose of, medical treatment. Furthermore, the term “patient” may be used herein to reference an entity for which medical records are sought or stored, or to an entity seeking medical treatment or diagnosis. A patient may, for example, be an individual, a family or family member, an insurance policy holder or dependent, or a group of individuals such as a company or corporate group.

The embodiments described here are relevant to electronic storage devices, computers, communications networks, web browsers, or any other system or device used for browsing ad storing informational resources such as web pages, documents, images, or the like.

Embodiments of the present principles can take the form of an entirely hardware embodiment, an entirely software embodiment or an embodiment including both hardware and software elements. In a preferred embodiment, the present principles are implemented in software, which includes but is not limited to firmware, resident software, microcode, etc.

Furthermore, the present principles can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The methods and systems disclosed herein may be implemented as web pages accessed via a web browser. Alternatively, the system may be advantageously embodied as a standalone software program, or as any combination of standalone software and web pages. The system may take on any form where software is capable of collecting, compiling, and providing medical records to a portable records storage device. Hereinafter, where the present principles are referred to as being embodied in software, any embodiment of the present principles may be implemented without deviating from the scope of the present principles.

Any modules or layers discussed as elements of an apparatus or system may be disposed on separate computing devices, or may be disposed, in any combination, on a single computing device, or across multiple computing devices. Skilled artisans will recognize that the physical deployment of modules is immaterial, as long as modules are communicatively connected to each other, where necessary.

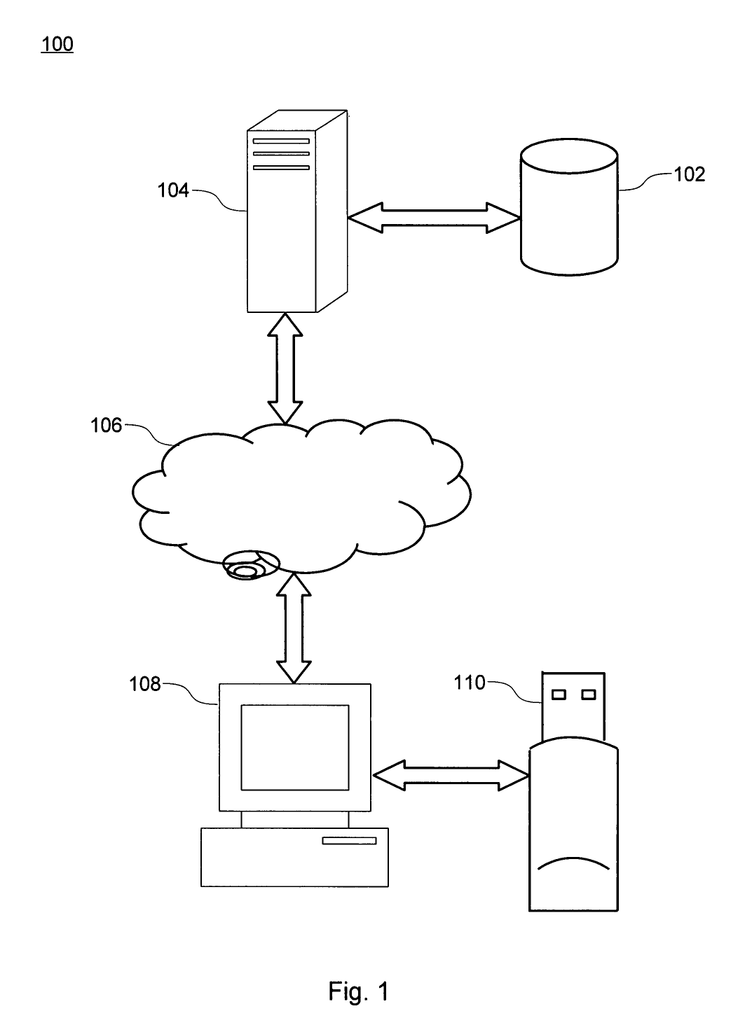

Referring now to the drawings in which like numerals represent the same or similar elements and initially to FIG. 1, a network 100 for communication between a client computer 108 and a medical records service according to the present principles is depicted. In one particularly useful embodiment, a server 104 may have a database 102 for storage of medical records and the like. The server 104 communicates over a computer network 106 with a client computer 108. The server 104 may advantageously be a web server configured to provide files from the database 102 to the client computer 108. The computer network 106 may be the Internet, but may also be any Ethernet network, a direct connection, a local area network (LAN), a wide area network (WAN), a wireless network, or any other known or as yet undiscovered communications network.

The client computer 108 maybe used by a patient to access the medical records service. The client computer 108 may be any general or special purpose commuting device capable of transferring files to and from the server 104 of medical records service. The client computer 108 may be configured to transfer medical records received from the medical records service server 104 to a portable records storage (PRS) device 110. In particularly useful embodiments, the PRS device 110 may be a memory device connectable to the client computer via a universal serial bus (USB) plug. USB keys employing flash memory are known to the art to be rugged, yet with a small form factor. Such properties permit a patient to easily carry electronic copies of their medical records with them. For example, a USB key may have n attachment apparatus that permits the user to carry the USB key on their keychain, or to attach to another commonly used article so that the patient may always have their medical records with them.

Preferably, the PRS device 110 is a re-writable storage device, however, a write once device may also be used. Skilled artisans will recognize that a re-writable storage device permits a user to add, remove and modify files stored on the PRS device 110. In alternative, yet equally useful, embodiments, the PRS device may be any portable electronic storage device. For example, the PRS device 110 may be, but is not limited to, a smart card, a flash memory card, an electronically erasable and programmable read-only memory (EEPROM) device, a portable or fixed hard drive, an optical storage device such as a CR-ROM, CD-RW, DVD-ROM or DVD-RW, a floppy disk, a cassette or reel-to-reel tape, a portable electronic device having digital memory, or any other known or as yet undiscovered apparatus capable of storing electronic data.

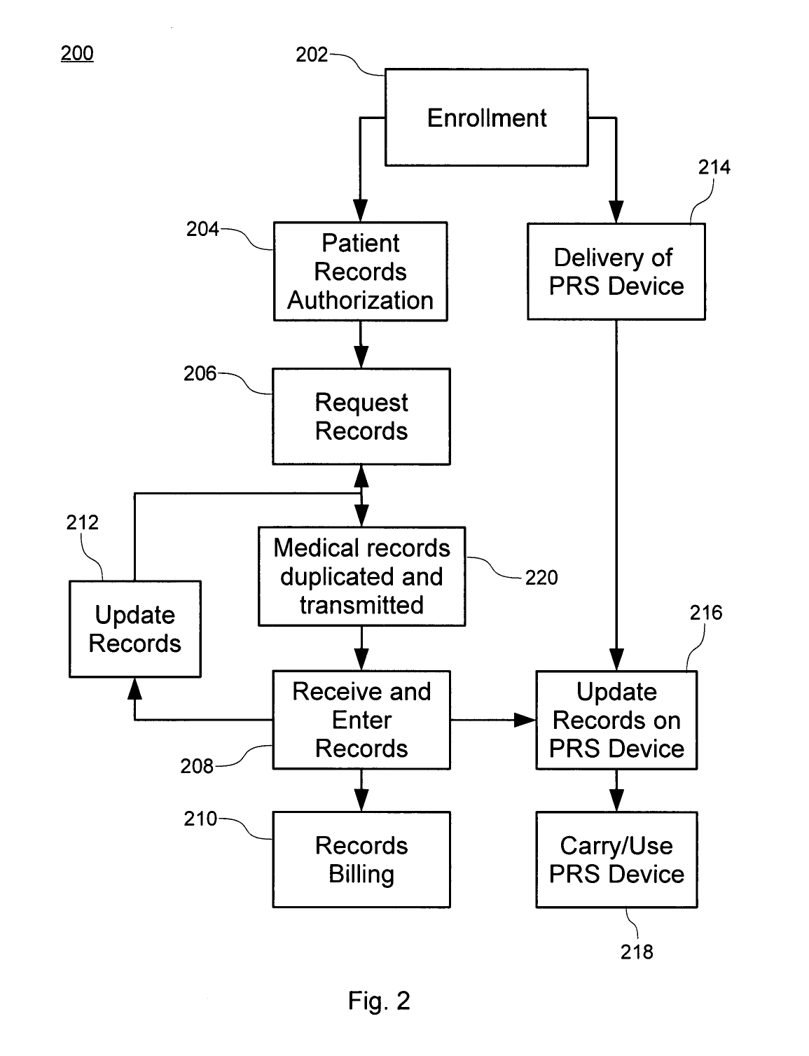

Referring now to FIG. 2, a method 200 for acquiring, compiling, updating and providing electronic medical records according to the present principles is shown. Initially, a medical records service provides enrollment for clients in step 202. The enrollment of step 202 may include elements such as gathering patient/subscriber information, payment information and the like. In particularly useful embodiments, the patent/subscriber may also fill out a digital health profile (DHP). Such a DHP may include, but is not limited to, information such as health history, family history, allergies, current medications and health provider information. The health history information may include information such as previous medical diagnoses, current medical conditions, prior immunizations and the like. The health provider information may include, for example, a list of current and former health services providers such as physicians, hospitals, specialists, pharmacies, therapists, and the like.

Many of medical services providers may charge a fee for providing copies of medical records. In some states the maximum allowable amount chargeable for medical records is set by state regulation. However, in other states, the permitted charge is per page, and in others, the charge is per hour, or a combination of hours and per page charges. In order to properly debit the patient for any records requested and retrieved from each service provider, the enrollment process of step 202 may include a blanket authorization for charges incurred, with a credit card, or some other debit account information kept on file with the medical records service. In one particularly useful embodiment, the records charge authorization may authorize a charge up to a specified, predetermined, threshold, with the patient may be required to give an additional authorization for any charges that will exceed the predetermined threshold.

In particularly useful embodiments, the enrollment may take place online, with a patient/subscriber submitting information on a website of the medical records service provider. After the medical records service enrolls the patient/subscriber in step 202, the medical records service then delivers the PRS device (110 of FIG. 1) to the patient in step 214.

The patient then delivers a patient records authorization to the medical records service provider in step 204. Due to privacy regulations, most medical services providers are prohibited from sharing the patient's medical records without explicit, signed authorization. Such a records authorization, as in step 204, permits the medical records service to gather any available medical records from the patient's medical services providers.

The medical records provider may advantageously accept the records authorization via fax or electronic submission. Alternatively, the medical records service provider may accept the records authorization in hard copy form, and convert or scan the hard copy authorization into an electronic copy. The use of an electronic copy of the records authorization advantageously permits the medical records service to easily track and duplicate the records authorization without manually handling it. Furthermore, electronic forms of the records authorization may be used when the medical records service system automatically generates a records request.

Once the medical records service has received the patent records authorization in block 206, the medical records service requests the patient's medical records from the patient's medical services providers in step 206. Here, the medical records service may use the medical services provider information entered by the patient as part of the DHP in step 202. Upon initial enrollment, the medical records service may request medical records from all of the patient's medical services providers, with additional requests occurring at regular intervals, or upon a patient visit to a medical service provider.

In general, the medical record service's records request of step 206 may be written, via fax, or by electronic submission. For example, where medical service providers are capable of accepting records requests via an electronic records request service, the medical records service may use an automated system to submit a properly formatted records request to the medical service provider. Alternatively, the medical records service may fax or mail a hard copy of the records request to the medical service provider. In one useful embodiment, the records request will include a current copy of the patient records authorization received in step 204. Where the records request is sent electronically, the records authorization may be stored as an image file, or as another widely used file format, and submitted from the medical records service's electronic data storage. Where the medical records request is submitted via fax, one useful embodiment may include the system of the medical records service automatically submitting requests for each medical service provider via a fax modem, permitting the medical records service to automate the records service request faxing process. Similarly, any medical records received via fax, and in response to a records request, may be received via a fax modem, and automatically entered into the data storage of the medical records service.

For medical service providers that only accept written hardcopy records requests, the medical records service may automate the printing of the records requests. For example, upon the initiation of a records request, the medical records service system may print forms such as, but not limited to, a standard form records request, optionally having the patient's information prefilled, along with the patient records authorization, mailing labels, or any other required forms.

In response to the records request of step 206, the medical services providers will, in step 220, generate copies of the records of the patient's records, and send the medical records to the medical records service. As stated above, some medical services providers may charge a duplication fee for copies of the medical records. In these cases, the medical services provider may generate a bill, or otherwise charge the patient or medical records service for the records duplication costs. In particularly useful embodiments, the records and billing may be submitted to the medical records service electronically by the medical services provider. However, the medical records may also, in equally useful embodiments, be faxed, or sent in hardcopy form, to the medical records service.

In step 208, the medical records provider receives the medical records from a medical services provider, and enters the records into the database (102 of FIG. 1). Where the medical records from the medical services provider are in hard copy form, received via fax or physical delivery, the medical records service may convert the physical records into an electronic format. For standardized records, the data from the medical records may me manually entered into the database (102 of FIG. 1), or the records may be scanned in and stored as an image. Additionally, when the medical records service receives records via fax, the medical records may be stored electronically directly from the fax.

Particularly useful embodiments may also include the indexing and annotation of the medical records during entry in step 208. For example, medical records may have a heading, title, or other meta data entered, permitting the efficient organization and referencing of he individual medical records.

Alternatively, a patient may be in possession of their medical records, having gathered copies on their own, or from other medical records services. Additionally, a patient may wish to submit additional records regarding their medical situation that were not generated by a medical services provider. These records may be submitted to the medical records service by the patient, and entered into the patient's file as any other record.

In step 212, a patient's medical records may be updated. In one useful embodiment, the medical records service may have a system in place to track the date of the last records update, and may automatically request updated copies of a patient's medical records from each of the patient's current medical services providers. In such an embodiment, the medical records service may request updates to medical records at regular, predetermined, intervals. For example, the medical records service may request any additional or updated records from a patient's medical services providers every 90 days. Of course, the actual interval at which updated records are requested may vary, depending on the circumstances of the medical records service, or depending on the patient or service provider.

In another useful embodiment, the regularly scheduled records update may be supplemented or supplanted by an Interactive Healthcare Calendar (IHC) trigger. With such an IHC trigger, the medical records provider may make a calendar system available to patients, permitting each patient to schedule and track appointments for medical visits with the patient's medical service providers. The IHC may automatically generate updated records requests in response to appointments listed in the IHC. For example, in a case where a patient who schedules a doctor's visit, and lists the doctor's visit with the IHC, the IHC may automatically generate a request for updated records from the doctor with which the patient had a visit scheduled. This request may be generated some predetermined time after the date of the scheduled appointment, with a delay between the patient's visit and the request being predetermined, or varying, depending on virtually any factor.

In yet another useful embodiment, a patient may also manually initiate a request for updated medical records in step 212. It should be understood that any request for updated records may be to a single medical services provider, or to a plurality, or all of a patient's medical services providers. Skilled artisans will recognize, for example, that a regularly scheduled records update may involve requesting updated records form all of a patient's medical services providers, while a record update initiated in response to an appointment entered into the IHC may only request updated records from the medical services provider with which a patient had an appointment scheduled.

In requesting updated records in step 212, the records request may advantageously request only those records created or updated since the last records request. Such a limitation on the request may lower records duplication costs for the patient.

After the records are received and entered by the medical records service in step 208, the medical records are provided to the patient to update the copies of the records on the PRS (110 of FIG. 1) in step 216. In one useful embodiment, the patient may connect their PRS delivered in step 214 to a client computer (108 of FIG. 1), and update the files on the PRS device (110 of FIG. 1) by accessing a website or server (104 of FIG. 1). The updated PRS device (110 of FIG. 1) may then be carried or used by the patient in step 218.

Records billing occurs in step 210 after the medical records are received and entered in step 208. In particularly useful embodiments, the medical services provider may send a bill for records duplication charges to the medical records service. The medical records service may manage the payment of the records billing by aggregating charges for a patient's account, ensuring that the medical services providers are properly paid.

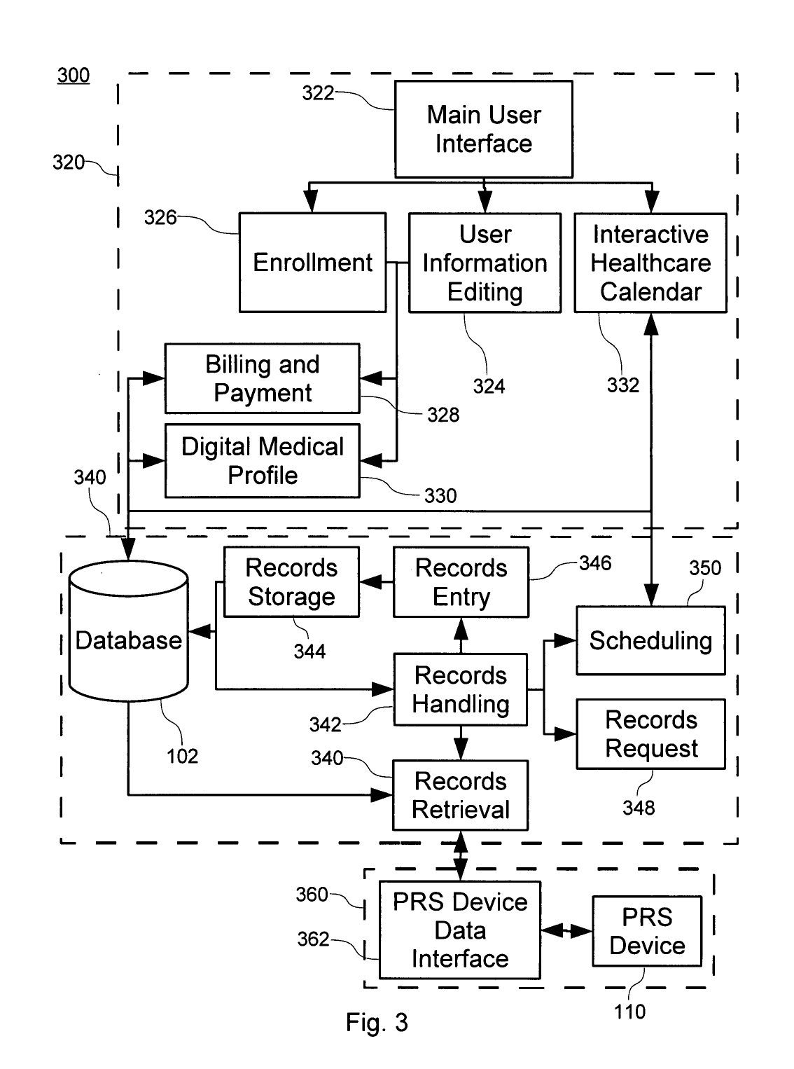

The system 300 for handling the collection, aggregation and provision of medical records in illustrated in FIG. 3. The system 300 may include an interface layer 320, a records layer 340, and a client layer 360.

The interface layer includes a main user interface module 322 configured to permit patients/subscribers to access the medical records service. The main user interface module 322 may be connected to an enrollment module 326, which may include a module for billing and payment 328, and a digital medical profile module 330. The enrollment module 326 provides patients with an interface to sign up with the medical records service, performing the enrollment of step 202 of FIG. 2. The billing and payment module 328 may collect and process the account information and payments for a particular patient/subscriber's account. In some implementations, the billing and payment module 328 may further include functionality for aggregating and debiting amounts incurred in connection with a medical service provider's duplication of medical records. In particularly useful embodiments, the billing and payment module 328 may automatically bill a patient's debit account for the costs of the medical records service, or for the records billing (210 of FIG. 2).

The digital medical profile module 330 is configured to gather the digital health profile (DHP), discussed above, from the patient. Additionally, medical information may also be submitted in hard copy form, and entered into the digital medical profile module 330 manually.

The digital medical profile module 330 and billing and payment module 328 may be connected to the database 102, permitting storage and retrieval of any information collected or displayed by the interface layer 320.

The interface layer 320 may further include a user information editing module 324 which permits a user to access, verify, edit or update any information associated with the patient's account. In one useful embodiment, the user information editing module 324 may permit a patient to access their medical records to view, delete, or add to, the listing of medical records for the patient.

The IHC 332 may further be part of the interface layer 320. As discussed above the IHC may provide a calendar service to patients so that patients may track medical appointments and visits. The IHC 332 may create triggers for the automatic creation of records update requests, with the timing of the updated records requests dependent on the appointments entered into the IHC 332 by patients.

The records layer 340 may, in particularly useful embodiments, handle the storage, retrieval and updating of patient information and medical records. The records layer 340 may include the data base 102, and a records handling module 342. The records handing module 342 may be used to control and regulate the entry, storage and retrieval of records stored in the data base 102. The records handling module 342 may be connected to a records entry module 346 configured to permit the scanning, entry, and reception of medical records. The records entry module 346 may be communicatively connected to the database 102 via a records storage module 344.

The records handling module 342 may be further connected to a records request module 348, which may be configured to generate records requests and records update requests. The records request module 348 may generate the paperwork necessary to request records from individual medical services providers. The records request module 348 may also be configured to electronically transmit records requests and records update requests to medical services providers. The records request module 348 may initiate the creation of records requests and updates when triggered by a scheduling module 350.

The scheduling module 350 may be configured to initiate records requests upon the initial enrollment of a patient, and to initiate records updates at regularly scheduled intervals, or upon an IHC trigger.

A records retrieval module 340 may be used to load a patient's medical records from the data base 102, and to aggregate and provide the medical records for loading onto a PRS device 110. Additionally, the records retrieval module 340 may be used to retrieve a patient's medical records for display by the main user interface 322 to a patient. Thus, medical records may be retrieved by the records retrieval module 340 so that the patient may review and manage the records included in the patient's medical records service account.

A client layer 360 may load and update records on the PRS device 110. A PRS device data interface 362 may be used to perform the actual updating and transfer of files into the PRS device 110. In one useful embodiment, the PRS device data interface 362 may reside on the client computer (108 of FIG. 1), polling the medical records service for updated records when the PRS device 110 is connected to the client computer (108 of FIG. 1). Upon determining that files on the PRS device 110 need to be updated, or that files exists that are not on the PRS device 110, the PRS device data interface module 362 may download the relevant files from the medical records service, and transfer the files to the PRS device 110. In another useful embodiment, the PRS device data interface module 362 may store, on the client computer 108, a local copy of all of the medical records files, updating the PRS device 110 when the PRS device 110 is connected to the client computer (108 of FIG. 1).

In an alternative embodiment, the PRS device data interface module 362 may reside on the PRS device 110, itself, and may be activated to update or load files onto the PRS device 110 upon connection of the PRS device 110 to a client computer (108 of FIG. 1).

In yet another useful embodiment, the PRS device data interface module 362 may be part of the medical records service website. In such an embodiment, the PRS device data interface module 362 may be a module activated when the PRS device 110 is connected to a client computer (108 of FIG. 1), and the patient navigates to the website.

Skilled artisans will recognize that the deployment of the PRS device data interface module 362 is immaterial, as long as the element exists for transferring the medical records from medical records service to the PRS device 110.

Having described preferred embodiments of a system and method for identifying the compatibility of users from identifying information gathered from web pages (which are intended to be illustrative and not limiting), it is noted that modifications and variations can be made by persons skilled in the art in light of the above teachings. It is therefore to be understood that changes may be made in the particular embodiments disclosed which are within the scope and spirit of the presented principles as outlined by the appended claims. Having thus described aspects of the present principles, with the details and particularity required by the patent laws, what is claimed and desired protected by Letters Patent is set forth in the appended claims.

What is claimed is:

1. A method for providing a medical records service comprising the steps of:
enrolling a patient, the enrolling comprising gathering information for at least one medical service provider of the patient;
receiving a records authorization to gather medical records for the patient;
requesting medical records from each of the medical services providers of the patient using the received records authorization;
receiving and entering the requested medical records into a database; and
copying and updating the medical records onto a portable records storage device.

2. The method of claim 1, further comprising:
requesting updated medical records from at least one of the medical service providers;
receiving the requested updated medical records; and
updating the medical records of the patient with the received updated medical records.

3. The method of claim 2, wherein medical records and updated medical records are requested automatically.

4. The method of claim 2, wherein the step of requesting updated medical records occurs in response to an event entered into an interactive healthcare calendar.

5. The method of claim 2, further comprising the step of automatically billing a patient for the costs incurred in connection with the requesting of medical records and the requesting of updated medical records.

6. The method of claim 1, further including the step of delivering a portable record storage device to a patient.

7. The method of claim 1, wherein the step of enrollment further comprises gathering a digital health profile of a patient.

8. An apparatus for providing a medical records service, the apparatus comprising:
a records layer having:
a database for storing of medical records and account information of patients;
a records entry module configured to collect and receive medical records of patients;
a records storage module configured to store, in the database, medical records collected and received by the records entry module; and
a records retrieval module configured to retrieve records from the database;
an interface layer having:
a billing and payment module configured to collect patient account billing and payment information, and configured to store the patient account billing and payment information into the database; and
a digital medical profile module configured to collect a digital medical profile of a patient, the digital medical profile comprising the medical service provider information of the patient, and configured to store the digital medical profile in the database; and
a client layer having:
a portable record storage device data interface configured to retrieve medical records through the records retrieval module, and configured to copy medical records onto a portable records storage device.

9. The apparatus of claim 8, further comprising a records request module configured to generate a records request for a medical services provider of a patient.

10. The apparatus of claim 9, wherein the records request module is further configured to automatically transmit a records request to a medical service provider of a patient.

11. The apparatus of claim 9, wherein the records request module is further configured to generate an updated records request for a medical services provider of a patient.

12. The apparatus of claim 11, further comprising a scheduling module configured to initiate updated records requests by the records request module.

13. The apparatus of claim 12, the scheduling module configured to initiate updated records requests by the records request module at predetermined intervals.

14. The apparatus of claim 12, further comprising an interactive healthcare calendar module configured to accept entry of appointments of patients, wherein each appointment is associated with at least one medical services provider, and wherein the interactive healthcare calendar module further configured to provide triggers to the scheduling module to initiate an updated records request, the trigger being provided in response to the passing of an entered appointment.

15. The apparatus of claim 8, further comprising a user information editing module configured to permit a user to view and manage medical records stored on the database.

16. The apparatus of claim 8, further comprising a portable records storage device for receiving medical records fro the portable records storage device data interface, and further configured to store the received medical records.

17. A method for providing a medical records service for gathering and storing medical records of a patient, the method comprising the steps of:
enrolling a patient, the enrolling comprising gathering information for at least one medical service provider of the patient;
receiving a records authorization to gather medical records for the patient;
requesting updated medical records from at least one of the medical service providers using the received records authorization;
receiving the requested updated medical records;
updating the medical records of the patient with the received updated medical records; and
billing a patient for the costs incurred in connection with the requesting of updated medical records.

18. The method of claim 17, further comprising:
requesting medical records from each of the medical services providers of the patient using the received records authorization; and
receiving and entering the requested medical records into a database.

19. The method of claim 17, further comprising the step of copying and updating the medical records onto a portable records storage device.

20. The method of claim 17, wherein the step of requesting updated medical records occurs in response to the elapse of an event entered into an interactive healthcare calendar.
